(19) United States
(12) Patent Application Publication
(10) Pub. No.: US 2011/0318670 A1
(43) Pub. Date: Dec. 29, 2011

(54) FUEL CELL MEA (MEMBRANE ELECTRODE ASSEMBLY) WITH A BORDER PACKAGING STRUCTURE

(75) Inventors: Jyun-Yi Lai, Taoyuan County (TW); Yu-Chih Lin, Taoyuan County (TW); Jiun-Ming Chen, Taoyuan County (TW); Chi-Yuan Chen, Taoyuan County (TW); Chiang-Wen Lai, Taoyuan County (TW); Kun-Fu Huang, Taoyuan County (TW)

(73) Assignee: NAN YA PCB CORP., Taoyuan County (TW)

(21) Appl. No.: 12/964,572

(22) Filed: Dec. 9, 2010

(30) Foreign Application Priority Data
Jun. 28, 2010 (TW) TW99121000

(51) Int. Cl. H01M 8/10

(52) U.S. Cl. 429/483

(57) ABSTRACT

A fuel cell MEA with a border packaging structure. A catalyst coated membrane includes an anode catalyst layer, a cathode catalyst layer, and a proton exchange membrane disposed therebetween. An anode border packaging member is connected between the anode catalyst layer and an anode gas diffusion layer. A cathode border packaging member is connected between the cathode catalyst layer and a cathode gas diffusion layer and adheres to the anode border packaging member at outer edges of the catalyst coated membrane. The anode border packaging member and the cathode border packaging member respectively include two adhesive layers and a substrate layer formed therebetween. The anode border packaging member and the cathode border packaging member are respectively connected between the anode catalyst layer and the anode gas diffusion layer and between the cathode catalyst layer and the cathode gas diffusion layer by the adhesive layers.

### CROSS REFERENCE TO RELATED APPLICATIONS

This Application claims priority of Taiwan Patent Application No. 099121000, filed on Jun. 28, 2010, the entirety of which is incorporated by reference herein.

### BACKGROUND OF THE INVENTION

1. Field of the Invention

The invention relates to a fuel cell MEA (membrane electrode assembly) with a border packaging structure, and more particularly to a fuel cell MEA (membrane electrode assembly) with a border packaging structure effectively preventing leakage of fuel.

2. Description of the Related Art

Fuel cells employ fuel, such as methanol or hydrogen, and oxygen (or air) to generate electricity. To enable an electrochemical reaction (or a redox reaction) in a fuel cell, fuel and oxygen (or air) are respectively transported into the fuel cell via proper passages. For example, for a fuel cell employing hydrogen (H₂) as the fuel, the hydrogen (H₂) and oxygen (or air) are respectively transported to an anode reaction side (or an anode catalyst layer) and a cathode reaction side (or a cathode catalyst layer) of a membrane electrode assembly via an anode gas diffusion layer and a cathode gas diffusion layer, performing the redox reaction. Here, the redox reaction at the anode reaction side and cathode reaction side is as follows.

At the anode reaction side: H₂→2H⁺+2e⁻

At the cathode reaction side: ½O₂+2H⁺+2e⁻→H₂O

Accordingly, if the hydrogen (H₂) at the anode reaction side and the oxygen (or air) at the cathode reaction side leak to the exterior of the fuel cell or mix with each other within the fuel cell, a performance of the fuel cell could deteriorate or an explosion thereof could even occur. Thus, to prevent the hydrogen (H₂) at the anode reaction side and the oxygen (or air) at the cathode reaction side from leaking to the exterior of the fuel cell or mixing with each other within the fuel cell, border packaging members are widely employed in the fuel cell MEA (membrane electrode assembly).

Nevertheless, the conventional border packaging members employed in the fuel cell MEA (membrane electrode assembly) are provided with weak adhesion and insufficient support strength, still easily causing the fuel and oxygen (or air) to leak to the exterior of the fuel cell or mix with each other within the fuel cell.

### BRIEF SUMMARY OF THE INVENTION

A detailed description is given in the following embodiments with reference to the accompanying drawings.

An exemplary embodiment of the invention provides a fuel cell MEA (membrane electrode assembly) with a border packaging structure, comprising a catalyst coated membrane, an anode gas diffusion layer, a cathode gas diffusion layer, an anode border packaging member, and a cathode border packaging member. The catalyst coated membrane comprises a proton exchange membrane, an anode catalyst layer, and a cathode catalyst layer. The proton exchange membrane is disposed between the anode catalyst layer and the cathode catalyst layer. The anode border packaging member is connected between the anode catalyst layer of the catalyst coated membrane and the anode gas diffusion layer. The cathode border packaging member is connected between the cathode catalyst layer of the catalyst coated membrane and the cathode gas diffusion layer and adheres to the anode border packaging member at outer edges of the catalyst coated membrane. The anode border packaging member and cathode border packaging member respectively comprise a substrate layer and two adhesive layers. The substrate layer is formed between the adhesive layers. The anode border packaging member is connected between the anode catalyst layer of the catalyst coated membrane and the anode gas diffusion layer by the adhesive layers. The cathode border packaging member is connected between the cathode catalyst layer of the catalyst coated membrane and the cathode gas diffusion layer by the adhesive layers.

The substrate layer comprises a fiber material or a film.

The fiber material is selected from a group consisting of a fiberglass cloth, nylon, a polyester cloth, and Kevlar paper.

The film is selected from a group consisting of a polyester film and a polycarbonate film.

The adhesive layers comprise a thermoplastic material or a thermosetting material.

The thermoplastic material is selected from a group consisting of a modified polyester film, PVDF, a thermoplastic fluoroelastomer, an aromatic condensation polymer, modified polyethylene, modified polypropylene, polyethylene, polypropylene, a thermoplastic elastomer, and aromatic polyamide.

The thermosetting material is selected from a group consisting of epoxy resin and silicone.

### BRIEF DESCRIPTION OF THE DRAWINGS

The invention can be more fully understood by reading the subsequent detailed description and examples with references made to the accompanying drawings, wherein:

FIG. 1 is a schematic cross section of a fuel cell MEA (membrane electrode assembly) with a border packaging structure of the invention;

FIG. 2 is a schematic view showing manufacturing of an anode border packaging member or a cathode border packaging member of the fuel cell MEA (membrane electrode assembly) of the invention;

FIG. 3 is a schematic view showing another manufacturing of an anode border packaging member or a cathode border packaging member of the fuel cell MEA (membrane electrode assembly) of the invention;

FIG. 4 is a schematic view showing still another manufacturing of an anode border packaging member or a cathode border packaging member of the fuel cell MEA (membrane electrode assembly) of the invention; and

FIG. 5 is a schematic view showing manufacturing of the fuel cell MEA (membrane electrode assembly) of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

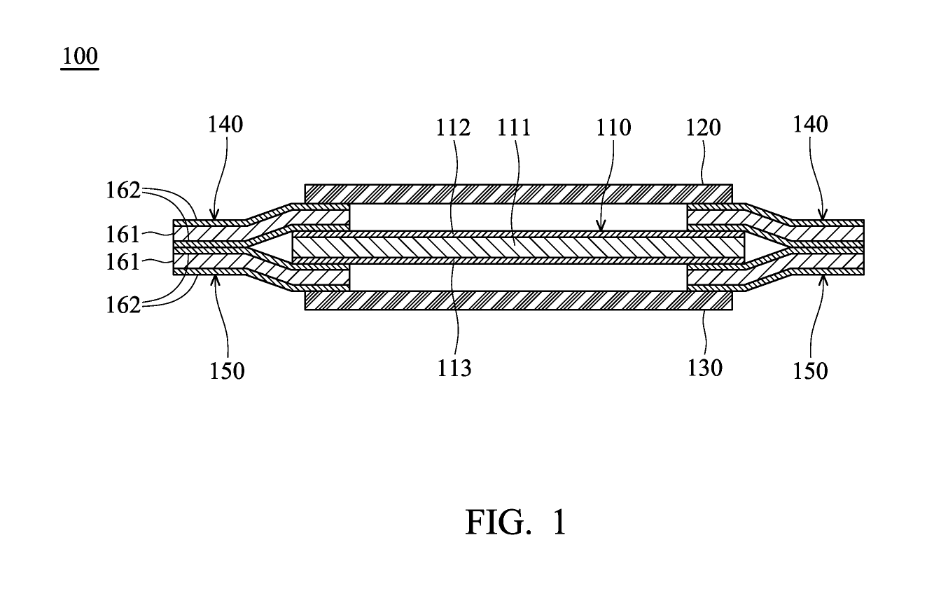

Referring to FIG. 1, a fuel cell MEA (membrane electrode assembly) 100 with a border packaging structure comprises a catalyst coated membrane 110, an anode gas diffusion layer 120, a cathode gas diffusion layer 130, an anode border packaging member 140, and a cathode border packaging member 150.

The catalyst coated membrane 110 comprises a proton exchange membrane 111, an anode catalyst layer 112, and a cathode catalyst layer 113. The proton exchange membrane 111 is disposed between the anode catalyst layer 112 and the cathode catalyst layer 113. Here, a redox reaction of the fuel cell MEA (membrane electrode assembly) 100 is performed at the anode catalyst layer 112 and the cathode catalyst layer 113, and protons are transmitted from the anode catalyst layer 112 to the cathode catalyst layer 113 through the proton exchange membrane 111.

The anode gas diffusion layer 120 and the cathode gas diffusion layer 130 respectively transport fuel and oxygen (or air) to the anode catalyst layer 112 and the cathode catalyst layer 113. Moreover, the anode gas diffusion layer 120 and the cathode gas diffusion layer 130 can conduct electric currents generated by the redox reaction.

The anode border packaging member 140 is connected between the anode catalyst layer 112 of the catalyst coated membrane 110 and the anode gas diffusion layer 120.

The cathode border packaging member 150 is connected between the cathode catalyst layer 113 of the catalyst coated membrane 110 and the cathode gas diffusion layer 130. Specifically, the cathode border packaging member 150 adheres to the anode border packaging member 140 at outer edges of the catalyst coated membrane 110.

In this embodiment, the anode border packaging member 140 and cathode border packaging member 150 may have the same structure and respectively comprise a substrate layer 161 and two adhesive layers 162. The substrate layer 161 is formed between the adhesive layers 162 and is provided with proper support strength and flexibility. Here, the substrate layer 161 may comprise a fiber material or a film. For example, the fiber material may be a fiberglass cloth, nylon, a polyester cloth, or Kevlar paper. Moreover, the substrate layer 161 may be a polyester film or a polycarbonate film. Additionally, the adhesive layers 162 may comprise a thermoplastic material or a thermosetting material. For example, the thermoplastic material may be a modified polyester film, PVDF, a thermoplastic fluoroelastomer, an aromatic condensation polymer, modified polyethylene, modified polypropylene, polyethylene, polypropylene, a thermoplastic elastomer, or aromatic polyamide, and the thermosetting material may be epoxy resin or silicone.

The anode border packaging member 140 or cathode border packaging member 150 can be manufactured by the following methods.

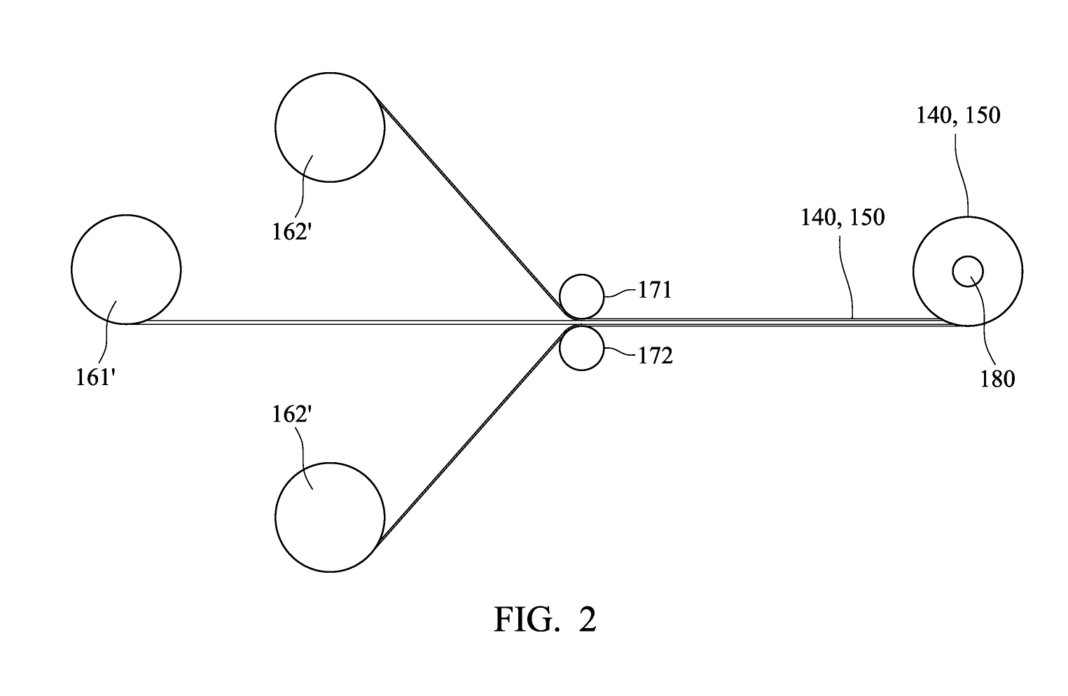

Referring to FIG. 2, a substrate layer rolled-up material 161′ having the same composition as the substrate layer 161 and two adhesive layer rolled-up materials 162′ having the same composition as the adhesive layers 162 can be formed into the anode border packaging member 140 or cathode border packaging member 150 by heating and pressurized rolling of a top hot pressing roller 171 and a bottom hot pressing roller 172. Here, the adhesive layers 162 must be applied with a proper temperature and a proper pressure to provide adhesion properties, such that the adhesive layers 162 can be bonded to the substrate layer 161. Next, the anode border packaging member 140 or cathode border packaging member 150 can be collected by rolling of a reel 180. The collected anode border packaging member 140 or cathode border packaging member 150 can then be properly trimmed to be employed in the fuel cell MEA (membrane electrode assembly) 100.

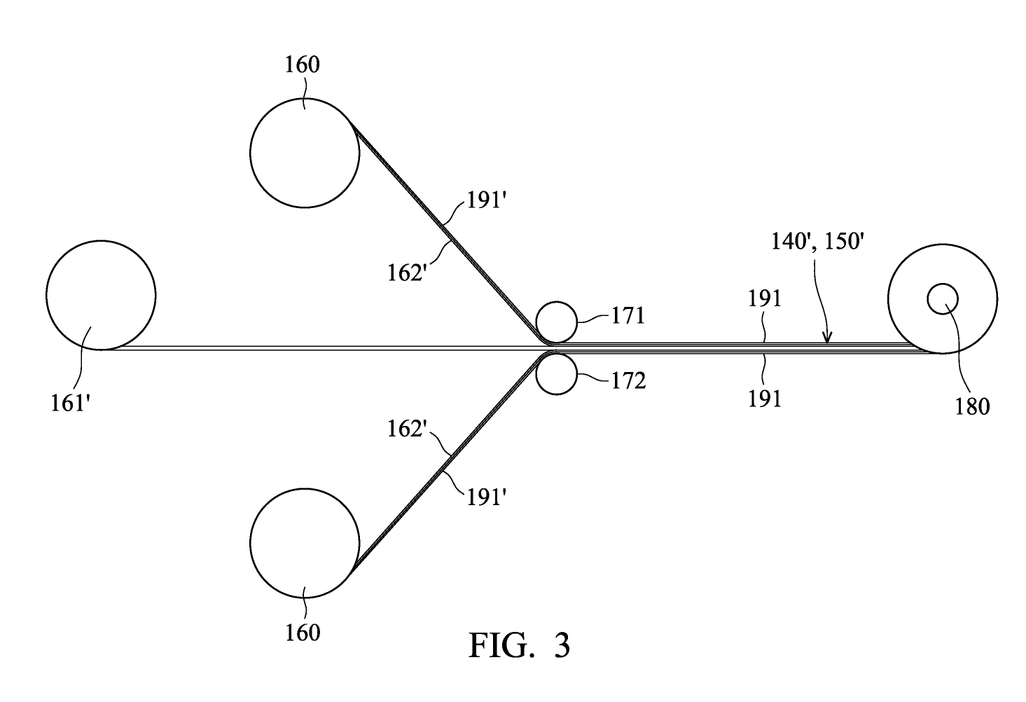

Referring to FIG. 3, the substrate layer rolled-up material 161′ and two rolled-up materials 160 (preformed by the adhesive layer rolled-up materials 162′ and backing sheet rolled-up materials 191′) can be formed into an anode border packaging member 140′ containing two backing sheets 191 or a cathode border packaging member 150′ containing two backing sheets 191 by heating and pressurized rolling of a top hot pressing roller 171 and a bottom hot pressing roller 172. Specifically, the backing sheet rolled-up materials 191′ or backing sheets 191 can maintain a stable thickness for the anode border packaging member 140′ or cathode border packaging member 150′ when the adhesive layer rolled-up materials 162′ (or adhesive layers 162) are attached to the substrate layer rolled-up material 161′ (or substrate layer 161). Similarly, the adhesive layers 162 must be applied with a proper temperature and a proper pressure to provide adhesion properties, such that the adhesive layers 162 can be bonded to the substrate layer 161. Then, the anode border packaging member 140′ or cathode border packaging member 150′ can be collected by the rolling of the reel 180. When the collected anode border packaging member 140′ or cathode border packaging member 150′ needs to be employed, the backing sheets 191 can be removed therefrom to form the anode border packaging member 140 or cathode border packaging member 150. Then, the anode border packaging member 140 or cathode border packaging member 150 can be properly trimmed to be employed in the fuel cell MEA (membrane electrode assembly) 100. Additionally, the backing sheets 191 of this embodiment may be composed of PET.

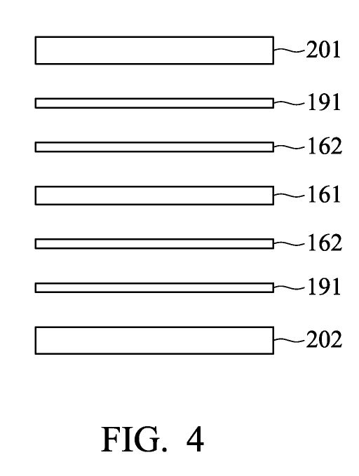

Referring to FIG. 4, a substrate layer 161, two adhesive layers 162, and two backing sheets 191 are placed between a top press tool 201 and a bottom press tool 202 and are bonded together by heating and pressing of the top press tool 201 and bottom press tool 202. Similarly, the backing sheets 191 for maintaining a stable profile of the adhesive layers 162 can be removed therefrom, thereby forming the anode border packaging member 140 or cathode border packaging member 150.

Moreover, the fuel cell MEA (membrane electrode assembly) 100 with a border packaging structure of this embodiment can be manufactured by the following method.

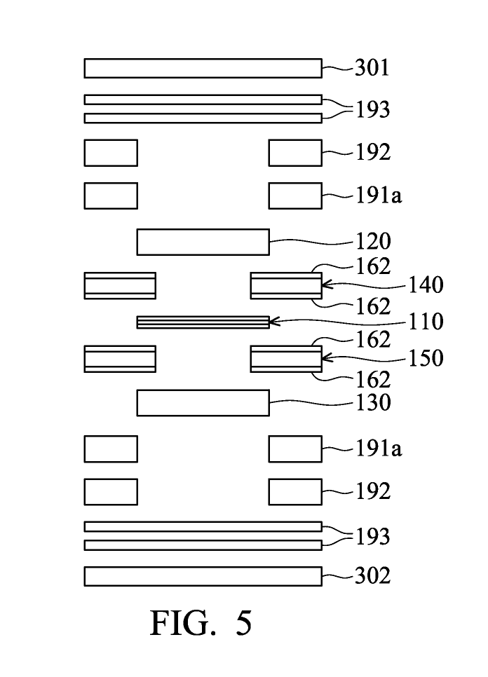

Referring to FIG. 5, a catalyst coated membrane 110, an anode border packaging member 140, a cathode border packaging member 150, an anode gas diffusion layer 120, a cathode gas diffusion layer 130, two backing sheets 191a, two first backing papers 192, and a plurality of second backing papers 193 are placed between a top stacking tool 301 and a bottom stacking tool 302. Here, the first backing papers 192 and second backing papers 193 can overcome tolerances generated by the top stacking tool 301 and bottom stacking tool 302, and the backing sheets 191a can enhance removal of the first backing papers 192 from the adhesive layers 162 of the anode border packaging member 140 and cathode border packaging member 150. Then, the aforementioned semi-finished product with the top stacking tool 301 and bottom stacking tool 302 is placed in a hot press (not shown) to be thermally pressed. After the aforementioned procedure of thermal pressing is finished, the top stacking tool 301, bottom stacking tool 302, first backing papers 192, second backing papers 193, and backing sheets 191a can be removed, forming the fuel cell MEA (membrane electrode assembly) 100 with a border packaging structure.

Accordingly, in this embodiment, the anode border packaging member 140 is connected (or attached) between the anode catalyst layer 112 of the catalyst coated membrane 110 and the anode gas diffusion layer 120 by the adhesive layers 162, and the cathode border packaging member 150 is connected (or attached) between the cathode catalyst layer 113 of the catalyst coated membrane 110 and the cathode gas diffusion layer 130 by the adhesive layers 162. Furthermore, the anode border packaging member 140 and cathode border packaging member 150 adhere to each other at the outer edges of the catalyst coated membrane 110, and the substrate layers 161 of the anode border packaging member 140 and cathode border packaging member 150 can provide proper support strength. Thus, even though the fuel cell MEA (membrane electrode assembly) 100 is subjected to long-term discharge, the anode border packaging member 140 and/or cathode border packaging member 150 do not separate from the catalyst coated membrane 110 and anode gas diffusion layer 120 and/or separate from the catalyst coated membrane 110 and cathode gas diffusion layer 130 due to insufficient adhesion or support strength, thereby providing a gastight effect for the fuel cell MEA (membrane electrode assembly) 100, and further preventing the fuel at the anode reaction side (or anode catalyst layer 112) and the oxygen (or air) at the cathode reaction side (or cathode catalyst layer 113) from leaking to the exterior of the fuel cell MEA (membrane electrode assembly) 100 or mixing with each other within the fuel cell. Moreover, the anode border packaging member 140 and cathode border packaging member 150 can effectively fix the catalyst coated membrane 110, anode gas diffusion layer 120, and cathode gas diffusion layer 130, thus preventing alignment failures when multiple fuel cell MEAs (membrane electrode assemblies) 100 are assembled into a fuel cell stack.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fuel cell MEA (membrane electrode assembly) with a border packaging structure, comprising:
a catalyst coated membrane comprising a proton exchange membrane, an anode catalyst layer, and a cathode catalyst layer, wherein the proton exchange membrane is disposed between the anode catalyst layer and the cathode catalyst layer;
an anode gas diffusion layer;
a cathode gas diffusion layer;
an anode border packaging member connected between the anode catalyst layer of the catalyst coated membrane and the anode gas diffusion layer; and
a cathode border packaging member connected between the cathode catalyst layer of the catalyst coated membrane and the cathode gas diffusion layer and adhering to the anode border packaging member at outer edges of the catalyst coated membrane, wherein the anode border packaging member and the cathode border packaging member respectively comprise a substrate layer and two adhesive layers, the substrate layer is formed between the adhesive layers, the anode border packaging member is connected between the anode catalyst layer of the catalyst coated membrane and the anode gas diffusion layer by the adhesive layers, and the cathode border packaging member is connected between the cathode catalyst layer of the catalyst coated membrane and the cathode gas diffusion layer by the adhesive layers.

2. The fuel cell MEA (membrane electrode assembly) with a border packaging structure as claimed in claim 1, wherein the substrate layer comprises a fiber material or a film.

3. The fuel cell MEA (membrane electrode assembly) with a border packaging structure as claimed in claim 2, wherein the fiber material is selected from a group consisting of a fiberglass cloth, nylon, a polyester cloth, and Kevlar paper.

4. The fuel cell MEA (membrane electrode assembly) with a border packaging structure as claimed in claim 2, wherein the film is selected from a group consisting of a polyester film and a polycarbonate film.

5. The fuel cell MEA (membrane electrode assembly) with a border packaging structure as claimed in claim 1, wherein the adhesive layers comprise a thermoplastic material or a thermosetting material.

6. The fuel cell MEA (membrane electrode assembly) with a border packaging structure as claimed in claim 5, wherein the thermoplastic material is selected from a group consisting of a modified polyester film, PVDF, a thermoplastic fluoroelastomer, an aromatic condensation polymer, modified polyethylene, modified polypropylene, polyethylene, polypropylene, a thermoplastic elastomer, and aromatic polyamide.

7. The fuel cell MEA (membrane electrode assembly) with a border packaging structure as claimed in claim 5, wherein the thermosetting material is selected from a group consisting of epoxy resin and silicone.
